(19) United States
(12) Patent Application Publication
(10) Pub. No.: US 2025/0200876 A1
(43) Pub. Date: Jun. 19, 2025

(54) DATA TRANSMISSION METHOD AND DEVICE

(71) Applicant: Beijing Zitiao Network Technology Co., Ltd., Beijing (CN)

(72) Inventors: Xiaofei FANG, Beijing (CN); Bo LIU, Beijing (CN)

(21) Appl. No.: 18/928,517

(22) Filed: Oct. 28, 2024

(30) Foreign Application Priority Data
Dec. 13, 2023 (CN) 202311716217.8

(51) Int. Cl. G06T 17/00

(52) U.S. Cl. CPC G06T 17/00

(57) ABSTRACT

The present disclosure provides a data transmission method and a device. The data transmission method is applied to a virtual reality device including an application layer, a service layer, a hardware abstraction layer, and a kernel. The method includes: send, by the application layer, an image processing request including a to-be-processed image and a corresponding first handle to the hardware abstraction layer through the service layer; determining, by the hardware abstraction layer, a second handle corresponding to the first handle, and establishing a mapping relationship among the first handle, the to-be-processed image, and the second handle; sending, by the hardware abstraction layer, the mapping relationship to the kernel; and after the kernel completes processing of the to-be-processed image, sending, by the kernel, first notification data to the application layer based on the first handle, and sending second notification data to the hardware abstraction layer based on the second handle.

### CROSS-REFERENCE TO RELATED APPLICATIONS

This application claims priority to Chinese Patent Application No. 202311716217.8, filed on Dec. 13, 2023, which is hereby incorporated by reference in its entirety.

### TECHNICAL FIELD

Embodiments of the present disclosure relate to the field of virtual reality technologies, and in particular, to a data transmission method and a device.

### BACKGROUND

A virtual reality (VR) device is a computer simulation system that can create and experience a virtual world. The VR device uses a computer to generate a simulation environment, so that a user can be immersed in the environment.

The VR device has a high requirement for an image delay. However, a current VR device has a problem of a large delay when displaying an image.

### SUMMARY

According to a first aspect, an embodiment of the present disclosure provides a data transmission method, applied to a virtual reality device, where the virtual reality device includes an application layer, a service layer, a hardware abstraction layer, and a kernel, and the data transmission method includes: sending, the application layer, an image processing request to the hardware abstraction layer through the service layer, where the image processing request includes a to-be-processed image and a first handle corresponding to the to-be-processed image; determining, by the hardware abstraction layer, a second handle corresponding to the first handle, and establishing a mapping relationship among the first handle, the to-be-processed image, and the second handle; sending, by the hardware abstraction layer, the mapping relationship to the kernel; and after the kernel completes processing of the to-be-processed image, sending, by the kernel, first notification data to the application layer based on the first handle, and sending second notification data to the hardware abstraction layer based on the second handle, where the first notification data is used to notify the application layer that the processing of the to-be-processed image is completed, and the second notification data is used to notify the hardware abstraction layer that the processing of the to-be-processed image is completed.

According to a second aspect, an embodiment of the present disclosure provides a virtual reality device, including an application layer, a service layer, a hardware abstraction layer, and a kernel, where
an obtaining unit is configured to obtain an initial image;
a determining unit is configured to determine a first image and a second image in the initial image, where the first image is an area image corresponding to a tracking area of a user eye in the initial image, and the second image includes an area other than the first image in the initial image;
a sampling unit is configured to perform down-sampling on the second image to obtain a third image, where a size of the third image is the same as a size of the second image, and a pixel density of the third image is lower than a pixel density of the second image; and
a rendering unit is configured to render and combine the first image and the third image to obtain a target image to be displayed.

According to a third aspect, an embodiment of the present disclosure provides an electronic device, including at least one processor and a memory, where
the memory stores a computer-executable instruction; and
the at least one processor executes the computer-executable instruction stored in the memory, such that the at least one processor executes the data transmission method provided in the first aspect.

According to a fourth aspect, an embodiment of the present disclosure provides a computer-readable storage medium storing a computer-executable instruction, where when a processor executes the computer-executable instruction, the data transmission method provided in the first aspect is implemented.

According to a fifth aspect, one or more embodiments of the present disclosure provide a computer program product including a computer-executable instruction, where when a processor executes the computer-executable instruction, the data transmission method provided in the first aspect is implemented.

### BRIEF DESCRIPTION OF DRAWINGS

In order to more clearly describe the embodiments of the present disclosure or the technical solutions in the prior art, the following briefly describes the accompanying drawings used for describing the embodiments or the prior art. It is clear that the accompanying drawings in the following description show some embodiments of the present disclosure, and a person of ordinary skill in the art can still derive other drawings from these accompanying drawings without creative efforts.

FIG. 1 is an application scenario diagram of a data transmission method according to an embodiment of the present disclosure.

FIG. 2 is a flowchart of steps of a data transmission method according to an embodiment of the present disclosure.

FIG. 3 is a flowchart of steps of another data transmission method according to an embodiment of the present disclosure.

FIG. 4 is a block diagram of a structure of a virtual reality device according to an embodiment of the present disclosure.

FIG. 5 is a schematic diagram of a hardware structure of an electronic device according to an embodiment of the present disclosure.

### DESCRIPTION OF EMBODIMENTS

To make the objectives, technical solutions, and advantages of the embodiments of the present disclosure clearer, the technical solutions in the embodiments of the present disclosure are described clearly and completely below with reference to the accompanying drawings in the embodiments of the present disclosure. It is clear that the described embodiments are some rather than all of the embodiments of the present disclosure. All other embodiments obtained by a person of ordinary skill in the art based on the embodiments of the present disclosure without creative efforts shall fall within the protection scope of the present disclosure.

In the related art, data is transmitted by using a path from an image sensor to an image processor, to a kernel, to a camera provider layer, and then to an application layer. The path uses a traditional binder (an inter-process communication mechanism) transmission mechanism, so that the data transmission path is long, and a delay is high.

Based on the foregoing problems, in the data transmission method provided in the present disclosure, a lightweight IPC (another inter-process communication) communication mechanism is used, so that a system load of a VR device can be reduced. In addition, a data transmission link is improved from “data transmission by using a path from an image sensor to an application layer, to a service layer, to a hardware abstraction layer, to a kernel, to a camera privider (an independent process running in a system of the VR device), and then to the application layer” to “data transmission by using a path from the image sensor to the application layer, to the service layer, to the hardware abstraction layer, to the kernel, and then to the application layer”. In the present disclosure, data transmission does not need to pass through the camera privider, so that a data transmission path can be reduced, and a data transmission delay can be further reduced.

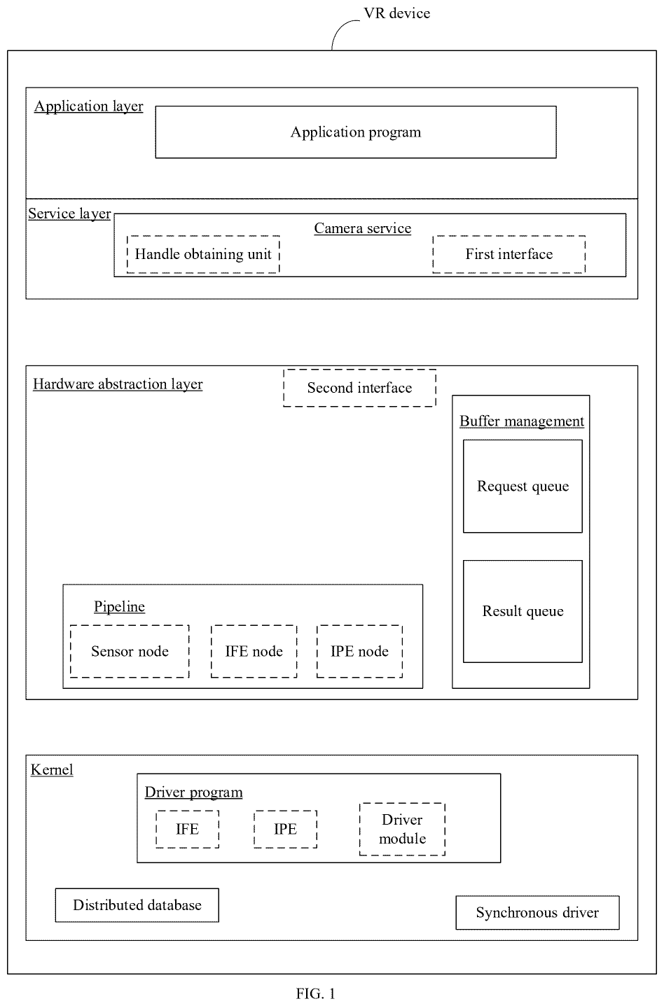

Referring to FIG. 1, an application scenario of the present disclosure is shown. A VR device is shown in FIG. 1. The VR device includes an application layer, a service layer, a hardware abstraction layer, and a kernel. Data in the VR device is transmitted and processed in the four layers, to reduce a delay.

FIG. 1 is merely an example of a scenario. The embodiments of the present disclosure may be applicable to image processing in any scenario.

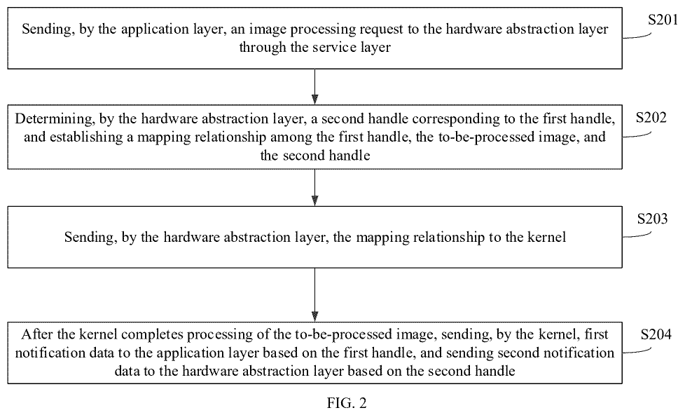

Reference is made to FIG. 2, which is a schematic flowchart of a data transmission method according to an embodiment of the present disclosure. As shown in FIG. 2, the data transmission method is applied to a virtual reality device. The virtual reality device includes an application layer, a service layer, a hardware abstraction layer, and a kernel. The method specifically includes the following steps.

S201: sending, by the application layer, an image processing request to the hardware abstraction layer through the service layer.

The image processing request includes a to-be-processed image and a first handle corresponding to the to-be-processed image.

Specifically, referring to FIG. 1, the application layer includes an application program, the service layer includes a camera service, the camera service includes a first interface, the application program sends the image processing request to the first interface, the first interface is connected to a second interface, and the first interface sends the image processing request to the second interface of the hardware abstraction layer.

In the present disclosure, the to-be-processed image and the first handle are in a one-to-one correspondence.

S202: determining, by the hardware abstraction layer, a second handle corresponding to the first handle, and establishing a mapping relationship among the first handle, the to-be-processed image, and the second handle.

The hardware abstraction layer obtains the second handle from the kernel after receiving the to-be-processed image and the first handle, binds the to-be-processed image, the first handle, and the second handle, and then may store the mapping relationship among the first handle, the to-be-processed image, and the second handle in the hardware abstraction layer.

In the present disclosure, the first handle (synx fence) is generated by the service layer, and is a synchronization handle used outside the hardware abstraction layer. The second handle (csl fence) is generated by the kernel, and is used inside the hardware abstraction layer.

S203: sending, by the hardware abstraction layer, the mapping relationship to the kernel.

In the embodiments of the present application, the hardware abstraction layer sends the bound mapping relationship to the kernel, that is, sends the to-be-processed image, the first handle, and the second handle to the kernel.

S204: after the kernel completes processing of the to-be-processed image, sending, by the kernel, first notification data to the application layer based on the first handle, and sending second notification data to the hardware abstraction layer based on the second handle.

The first notification data is used to notify the application layer that the processing of the to-be-processed image is completed, and the second notification data is used to notify the hardware abstraction layer that the processing of the to-be-processed image is completed.

Specifically, after receiving the mapping relationship, the kernel first processes the to-be-processed image. As shown in FIG. 1, an IPE (image processing engine) of a driver program in the kernel is used to perform denoising, sharpening, contrast adjustment, color adjustment, or the like on the to-be-processed image. In addition, if there is other processing, for example, image recognition or image extraction, the processing may be performed in an IFE (image front end). After the to-be-processed image is processed by the driver program, a target image is obtained. In this case, the kernel may send the first notification data to the application layer. The first notification data includes the first handle, and a user can view the corresponding target image through the application layer and the first handle.

Further, after receiving the image processing request, the hardware abstraction layer may store the image processing request in a request queue. If the hardware abstraction layer receives the second notification data sent by the kernel, the image processing request may be deleted from the request queue based on the second handle, to indicate that the content requested by the image processing request has been completed.

In the related art, notification data indicating that processing is completed is returned to the application layer in the original path (through the hardware abstraction layer and the service layer). In the embodiments of the present disclosure, the kernel directly sends the notification data to the application layer, which reduces a data transmission link, thereby reducing a data transmission delay.

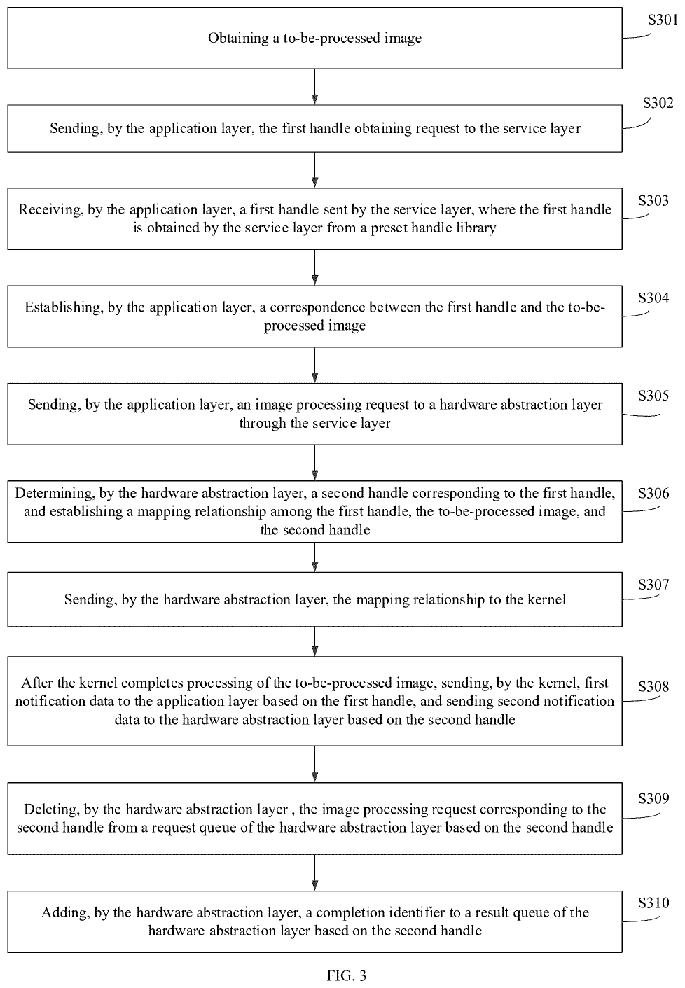

Reference is made to FIG. 3, which is a schematic flowchart of another data transmission method according to an embodiment of the present disclosure. As shown in FIG. 3, the data transmission method specifically includes the following steps.

S301: obtaining a to-be-processed image.

Specifically, before the application layer sends a first handle obtaining request to the service layer, the application layer receives the to-be-processed image sent by the image sensor, and the to-be-processed image is an image to be processed that is collected by a camera of the VR device.

S302: sending, by the application layer, the first handle obtaining request to the service layer.

Referring to FIG. 1, after receiving the to-be-processed image, an application program in the application layer sends the first handle obtaining request to a handle obtaining unit of a camera service in the service layer.

S303: receiving, by the application layer, a first handle sent by the service layer, where the first handle is obtained by the service layer from a preset handle library.

In the present disclosure, the service layer further includes the preset handle library. After receiving the first handle obtaining request, the handle obtaining unit responds to the first handle obtaining request, obtains the first handle from the preset handle library of the service layer, and sends the first handle to the application program.

S304: establishing, by the application layer, a correspondence between the first handle and the to-be-processed image.

In the embodiments of the present application, after receiving the first handle sent by the service layer, the application layer establishes the correspondence between the first handle and the to-be-processed image. The first handle and the to-be-processed image are in a one-to-one correspondence.

S305: sending, by the application layer, an image processing request to a hardware abstraction layer through the service layer.

For a specific implementation process of this step, refer to S301, and details are not described herein again.

S306: determining, by the hardware abstraction layer, a second handle corresponding to the first handle, and establishing a mapping relationship among the first handle, the to-be-processed image, and the second handle.

Specifically, referring to FIG. 1, the hardware abstraction layer includes a second interface, and the hardware abstraction layer may receive the image processing request sent by the service layer through the second interface. The second interface is, for example, a Chi interface (a type of interface). In addition, the second interface may be another type of interface, which is not limited here.

Specifically, it may be understood that after receiving the image processing request, which includes the to-be-processed image and the first handle, the service layer further searches for a handle identifier corresponding to the first handle from the preset handle library, generates a new image processing request based on the to-be-processed image and the handle identifier, and sends the new image processing request to the hardware abstraction layer. Then, the service layer sends the new image processing request to the hardware abstraction layer through inter-process communication, and the hardware abstraction layer obtains a corresponding first handle from a handle library in the hardware abstraction layer based on the handle identifier of the first handle. The content in the handle library in the hardware abstraction layer is the same as that in the preset handle library in the service layer.

Further, the hardware abstraction layer sends a second handle request to the kernel, and then receives the second handle sent by the kernel. Then, the hardware abstraction layer binds the to-be-processed image, the first handle, and the second handle.

In the embodiments of the present application, referring to FIG. 1, a pipeline may be used to establish the mapping relationship among the first handle, the to-be-processed image, and the second handle. The pipeline includes a sensor node (image sensor node), an image front end (IFE) node, and an image processing engine (IPE) node.

S307: sending, by the hardware abstraction layer, the mapping relationship to the kernel.

For a specific implementation process of this step, refer to S203, and details are not described herein again.

S308: after the kernel completes processing of the to-be-processed image, sending, by the kernel, first notification data to the application layer based on the first handle, and sending second notification data to the hardware abstraction layer based on the second handle.

Referring to FIG. 1, the kernel includes a driver program, a distributed database, and a synchronous driver. The driver program includes an IFE, an IPE, and a driver module.

The kernel includes the driver program, and the sending, by the kernel, first notification data to the application layer based on the first handle includes: sending, by the driver program, the first notification data to the application layer based on the first handle.

Specifically, after receiving the to-be-processed image, the first handle, and the second handle, the driver module in the driver program sends the to-be-processed image to the IFE and/or the IPE for processing. After the processing is completed, the driver module sends the second notification data to the hardware abstraction layer. The driver module sends the first handle to the synchronous driver or the distributed database.

In an optional embodiment, the kernel further includes the synchronous driver, and the sending, by the driver program, the first notification data to the application layer based on the first handle includes: sending, by the driver program, the first handle to the synchronous driver; and sending, by the synchronous driver, the first notification data to the application layer based on the first handle.

Specifically, the driver module sends the first handle to the synchronous driver, and the synchronous driver sends the first notification data to the application program of the application layer. The first notification data carries the first handle. After receiving the first notification data, the application layer may determine, based on the first handle, that the processing of the to-be-processed image is completed, so that a user can view, through interaction with the application program, a target image obtained after the to-be-processed image is processed.

In an optional embodiment, the kernel further includes the distributed database, and the sending, by the driver program, the first notification data to the application layer based on the first handle includes: sending, by the driver program, the first handle to the distributed database; and sending, by the distributed database, the first notification data to the application layer based on the first handle.

Specifically, the driver program may alternatively send the first handle to the distributed database, and the distributed database sends the first notification data to the application layer.

S309: deleting, by the hardware abstraction layer, the image processing request corresponding to the second handle from a request queue of the hardware abstraction layer based on the second handle.

In the embodiment of the present disclosure, after receiving the second notification data, the hardware abstraction layer deletes the image processing request from the request queue based on the second handle in the second notification data, to release resources.

S310: adding, by the hardware abstraction layer, a completion identifier to a result queue of the hardware abstraction layer based on the second handle.

The completion identifier indicates that processing of the to-be-processed image corresponding to the second handle is completed.

In the present disclosure, the lightweight IPC (another inter-process communication) communication mechanism is used, so that a system load of a VR device can be reduced. In addition, a data transmission link is improved from “data transmission by using a path from an image sensor to an application layer, to a service layer, to a hardware abstraction layer, to a kernel, to a camera privider (an independent process running in a system of the VR device), and then to the application layer” to “data transmission by using a path from the image sensor to the application layer, to the service layer, to the hardware abstraction layer, to the kernel, and then to the application layer”. In the present disclosure, data transmission does not need to pass through the camera privider, so that a data transmission path can be reduced, and a data transmission delay can be further reduced.

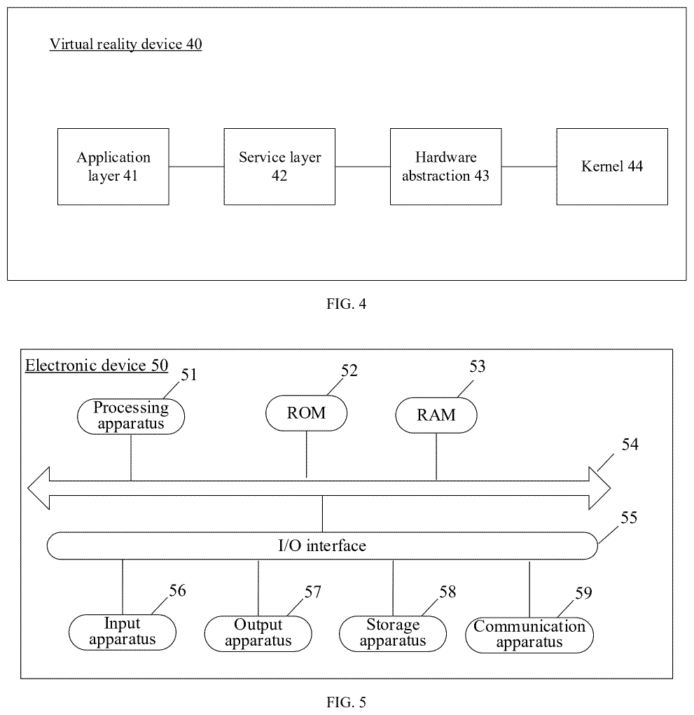

Corresponding to the data transmission method in the foregoing embodiment, FIG. 4 is a block diagram of a structure of a virtual reality device 40 according to an embodiment of the present disclosure. For ease of description, only parts related to the embodiments of the present disclosure are shown. As shown in FIG. 4, the virtual reality device 40 specifically includes an application layer 41, a service layer 42, a hardware abstraction layer 43, and a kernel 44, where
the application layer 41 is configured to send an image processing request to the hardware abstraction layer through the service layer, where the image processing request includes a to-be-processed image and a first handle corresponding to the to-be-processed image;
the hardware abstraction layer 42 is configured to determine a second handle corresponding to the first handle, and establish a mapping relationship among the first handle, the to-be-processed image, and the second handle;
the hardware abstraction layer 43 is configured to send the mapping relationship to the kernel; and
the kernel 44 is configured to: after the kernel 44 completes processing of the to-be-processed image, send first notification data to the application layer based on the first handle, and send second notification data to the hardware abstraction layer based on the second handle, where the first notification data is used to notify the application layer that the processing of the to-be-processed image is completed, and the second notification data is used to notify the hardware abstraction layer that the processing of the to-be-processed image is completed.

In some embodiments, the application layer 41 is further configured to: before sending the image processing request to the hardware abstraction layer through the service layer, obtain a to-be-processed image; send a first handle obtaining request to the service layer; receive a first handle sent by the service layer, where the first handle is obtained by the service layer from a preset handle library; and establish a correspondence between the first handle and the to-be-processed image.

In some embodiments, the hardware abstraction layer 43 is further configured to, after the second notification data includes the second handle, and the second notification data is sent to the hardware abstraction layer based on the second handle, delete the image processing request corresponding to the second handle from a request queue of the hardware abstraction layer based on the second handle.

In some embodiments, the hardware abstraction layer 43 is further configured to, after the second notification data is sent to the hardware abstraction layer based on the second handle, add a completion identifier to a result queue of the hardware abstraction layer based on the second handle, where the completion identifier indicates that processing of the to-be-processed image corresponding to the second handle is completed.

In some embodiments, the kernel includes a driver program, and the kernel 44 is specifically configured to: send, by the driver program, the first notification data to the application layer based on the first handle.

In some embodiments, the kernel further includes a synchronous driver, and the driver program is specifically configured to: send the first handle to the synchronous driver; and the synchronous driver sends the first notification data to the application layer based on the first handle.

In some embodiments, the kernel further includes a distributed database, and the driver program is specifically configured to: send the first handle to the distributed database; and the distributed database sends the first notification data to the application layer based on the first handle.

The virtual reality device provided in this embodiment may be configured to execute the technical solution of the embodiment of the data transmission method, and the implementation principle and the technical effect thereof are similar, and details are not described herein again in this embodiment.

Reference is made to FIG. 5, which shows a schematic diagram of a structure of an electronic device 50 suitable for implementing an embodiment of the present disclosure. The electronic device 50 may be a terminal device or a server. The terminal device may include, but is not limited to, mobile terminals such as a mobile phone, a notebook computer, a digital broadcast receiver, a personal digital assistant (PDA for short), a tablet computer (PAD for short), a portable media player (PMP for short), and a vehicle-mounted terminal (such as a vehicle navigation terminal), and fixed terminals such as a digital TV and a desktop computer. The electronic device 50 shown in FIG. 5 is merely an example, and shall not impose any limitation on the function and scope of use of the embodiments of the present disclosure.

As shown in FIG. 5, the electronic device 50 may include a processing apparatus (such as a central processing unit, a graphics processing unit, and the like) 51, which may perform various appropriate actions and processing in accordance with a program stored in a read-only memory (ROM) 52 or a program loaded from a storage apparatus 58 into a random access memory (RAM) 53. The RAM 53 further stores various programs and data required for the operation of the electronic device 50. The processing apparatus 51, the ROM 52, and the RAM 53 are connected to each other through a bus 54. An input/output (I/O) interface 55 is also connected to the bus 54.

Generally, the following apparatuses may be connected to the I/O interface 55: an input apparatus 56 including, for example, a touch screen, a touchpad, a keyboard, a mouse, a camera, a microphone, an accelerometer, and a gyroscope; an output apparatus 57 including, for example, a liquid crystal display (LCD), a speaker, and a vibrator; the storage apparatus 58 including, for example, a tape and a hard disk; and a communication apparatus 59. The communication apparatus 59 may allow the electronic device 50 to perform wireless or wired communication with other devices to exchange data. Although FIG. 5 shows the electronic device 50 having various apparatuses, it should be understood that it is not required to implement or have all of the shown apparatuses. It may be an alternative to implement or have more or fewer apparatuses.

In particular, according to an embodiment of the present disclosure, the process described above with reference to the flowcharts may be implemented as a computer software program. For example, this embodiment of the present disclosure includes a computer program product, which includes a computer program carried on a computer-readable medium, where the computer program includes a program code for performing the method shown in the flowchart. In such an embodiment, the computer program may be downloaded from a network through the communication apparatus 59 and installed, or installed from the storage apparatus 58, or installed from the ROM 52. When the computer program is executed by the processing apparatus 51, the above-mentioned functions defined in the method of the embodiment of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), and the like, or any suitable combination thereof.

The foregoing computer-readable medium may be contained in the foregoing electronic device; or may exist independently, without being assembled into the electronic device.

The foregoing computer-readable medium carries one or more programs that, when executed by the electronic device, cause the electronic device to perform the method shown in the foregoing embodiment.

Computer program code for performing operations of the present disclosure may be written in one or more programming languages or a combination thereof, where the programming languages include an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of involving a remote computer, the remote computer may be connected to a computer of a user over any type of network, including a local area network (LAN) or a wide area network (WAN), or may be connected to an external computer (for example, connected to the Internet using an Internet service provider).

The flowcharts and block diagrams in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that in some alternative implementations, the functions marked in the blocks may also occur in an order different from that marked in the accompanying drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

A unit involved in the embodiments described in the present disclosure may be implemented in a software manner, or may be implemented in a hardware manner. The name of a unit does not constitute a limitation on the unit itself in some cases. For example, a first obtaining unit may alternatively be described as “a unit for obtaining at least two Internet Protocol addresses”.

The functions described above herein may be performed at least partially by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination thereof. A more specific example of the machine-readable storage medium may include an electrical connection based on one or more wires, a portable computer disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof.

According to a first aspect, one or more embodiments of the present disclosure provide a data transmission method, applied to a virtual reality device, where the virtual reality device includes an application layer, a service layer, a hardware abstraction layer, and a kernel, and the data transmission method includes: sending, by the application layer, an image processing request to the hardware abstraction layer through the service layer, where the image processing request includes a to-be-processed image and a first handle corresponding to the to-be-processed image; determining, by the hardware abstraction layer, a second handle corresponding to the first handle, and establishing a mapping relationship among the first handle, the to-be-processed image, and the second handle; sending, by the hardware abstraction layer, the mapping relationship to the kernel; and after the kernel completes processing of the to-be-processed image, sending, by the kernel, first notification data to the application layer based on the first handle, and sending second notification data to the hardware abstraction layer based on the second handle, where the first notification data is used to notify the application layer that the processing of the to-be-processed image is completed, and the second notification data is used to notify the hardware abstraction layer that the processing of the to-be-processed image is completed.

According to one or more embodiments of the present disclosure, before the sending, by the application layer, the image processing request to the hardware abstraction layer through the service layer, the method further includes:
obtaining a to-be-processed image;
sending, by the application layer, a first handle obtaining request to the service layer;
receiving, by the application layer, a first handle sent by the service layer, where the first handle is obtained by the service layer from a preset handle library; and
establishing, by the application layer, a correspondence between the first handle and the to-be-processed image.

According to one or more embodiments of the present disclosure, the second notification data includes the second handle, and after the sending second notification data to the hardware abstraction layer based on the second handle, the method further includes:
deleting, by the hardware abstraction layer, the image processing request corresponding to the second handle from a request queue of the hardware abstraction layer based on the second handle.

According to one or more embodiments of the present disclosure, after the sending second notification data to the hardware abstraction layer based on the second handle, the method further includes:
adding, by the hardware abstraction layer, a completion identifier to a result queue of the hardware abstraction layer based on the second handle, where the completion identifier indicates that processing of the to-be-processed image corresponding to the second handle is completed.

According to one or more embodiments of the present disclosure, the kernel includes a driver program, and the sending, by the kernel, first notification data to the application layer based on the first handle includes:
sending, by the driver program, the first notification data to the application layer based on the first handle.

According to one or more embodiments of the present disclosure, the kernel further includes a synchronous driver, and the sending, by the driver program, the first notification data to the application layer based on the first handle includes:
sending, by the driver program, the first handle to the synchronous driver; and
sending, by the synchronous driver, the first notification data to the application layer based on the first handle.

According to one or more embodiments of the present disclosure, the kernel further includes a distributed database, and the sending, by the driver program, the first notification data to the application layer based on the first handle includes:
sending, the driver program, the first handle to the distributed database; and
sending, by the distributed database, the first notification data to the application layer based on the first handle.

According to a second aspect, one or more embodiments of the present disclosure provide a virtual reality device, including an application layer, a service layer, a hardware abstraction layer, and a kernel, where
the application layer is configured to send an image processing request to the hardware abstraction layer through the service layer, where the image processing request includes a to-be-processed image and a first handle corresponding to the to-be-processed image;
the hardware abstraction layer is configured to determine a second handle corresponding to the first handle, and establish a mapping relationship among the first handle, the to-be-processed image, and the second handle;
the hardware abstraction layer is configured to send the mapping relationship to the kernel; and
the kernel is configured to: after the kernel completes processing of the to-be-processed image, send first notification data to the application layer based on the first handle, and send second notification data to the hardware abstraction layer based on the second handle, where the first notification data is used to notify the application layer that the processing of the to-be-processed image is completed, and the second notification data is used to notify the hardware abstraction layer that the processing of the to-be-processed image is completed.

According to a third aspect, one or more embodiments of the present disclosure provide an electronic device, including at least one processor and a memory, where
the memory stores a computer-executable instruction; and
the at least one processor executes the computer-executable instruction stored in the memory, such that the at least one processor executes the data transmission method provided in the first aspect.

According to a fourth aspect, one or more embodiments of the present disclosure provide a computer-readable storage medium storing a computer-executable instruction, where when a processor executes the computer-executable instruction, the data transmission method provided in the first aspect is implemented.

According to a fifth aspect, one or more embodiments of the present disclosure provide a computer program product including a computer-executable instruction, where when a processor executes the computer-executable instruction, the data transmission method provided in the first aspect is implemented.

The foregoing descriptions are merely preferred embodiments of the present disclosure and explanations of the applied technical principles. A person skilled in the art should understand that the scope of disclosure involved in the present disclosure is not limited to the technical solution formed by a specific combination of the foregoing technical features, and shall also cover other technical solutions formed by any combination of the foregoing technical features or equivalent features thereof without departing from the foregoing concept of disclosure, for example, a technical solution formed by replacing the foregoing features with technical features with similar functions disclosed in the present disclosure (but not limited thereto).

In addition, although various operations are depicted in a specific order, it should not be understood as requiring these operations to be performed in the specific order shown or in a sequential order. Under specific circumstances, multitasking and parallel processing may be advantageous. Similarly, although several specific implementation details are included in the foregoing discussions, these details should not be construed as limiting the scope of the present disclosure. Some features that are described in the context of separate embodiments can alternatively be implemented in combination in a single embodiment. In contrast, various features described in the context of a single embodiment can alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. Instead, the specific features and actions described above are merely exemplary forms of implementing the claims.

What is claimed is:

1. A data transmission method, applied to a virtual reality device, wherein the virtual reality device comprises an application layer, a service layer, a hardware abstraction layer, and a kernel, and the data transmission method comprises:
sending, by the application layer, an image processing request to the hardware abstraction layer through the service layer, wherein the image processing request comprises a to-be-processed image and a first handle corresponding to the to-be-processed image;
determining, by the hardware abstraction layer, a second handle corresponding to the first handle, and establishing a mapping relationship among the first handle, the to-be-processed image, and the second handle;
sending, by the hardware abstraction layer, the mapping relationship to the kernel; and
after the kernel completes processing of the to-be-processed image, sending, by the kernel, first notification data to the application layer based on the first handle, and sending second notification data to the hardware abstraction layer based on the second handle, wherein the first notification data is used to notify the application layer that the processing of the to-be-processed image is completed, and the second notification data is used to notify the hardware abstraction layer that the processing of the to-be-processed image is completed.

2. The data transmission method according to claim 1, wherein before the sending, by the application layer, the image processing request to the hardware abstraction layer through the service layer, the method further comprises:
obtaining a to-be-processed image;
sending, by the application layer, a first handle obtaining request to the service layer;
receiving, by the application layer, a first handle sent by the service layer, wherein the first handle is obtained by the service layer from a preset handle library; and
establishing, by the application layer, a correspondence between the first handle and the to-be-processed image.

3. The data transmission method according to claim 1, wherein the second notification data comprises the second handle, and after the sending second notification data to the hardware abstraction layer based on the second handle, the method further comprises:
deleting, by the hardware abstraction layer, the image processing request corresponding to the second handle from a request queue of the hardware abstraction layer based on the second handle.

4. The data transmission method according to claim 3, wherein after the sending second notification data to the hardware abstraction layer based on the second handle, the method further comprises:
adding, by the hardware abstraction layer, a completion identifier to a result queue of the hardware abstraction layer based on the second handle, wherein the completion identifier indicates that processing of the to-be-processed image corresponding to the second handle is completed.

5. The data transmission method according to claim 1, wherein the kernel comprises a driver program, and the sending, by the kernel, first notification data to the application layer based on the first handle comprises:
sending, by the driver program, the first notification data to the application layer based on the first handle.

6. The data transmission method according to claim 5, wherein the kernel further comprises a synchronous driver, and the sending, by the driver program, the first notification data to the application layer based on the first handle comprises:
sending, by the driver program, the first handle to the synchronous driver; and
sending, by the synchronous driver, the first notification data to the application layer based on the first handle.

7. The data transmission method according to claim 5, wherein the kernel further comprises a distributed database, and the sending, by the driver program, the first notification data to the application layer based on the first handle comprises:
sending, by the driver program, the first handle to the distributed database; and
sending, by the distributed database, the first notification data to the application layer based on the first handle.

8. An electronic device, comprising at least one processor and a memory, wherein
the memory stores a computer-executable instruction; and
the at least one processor executes the computer-executable instruction stored in the memory, such that the at least one processor executes steps of:
sending, by an application layer of the device, an image processing request to a hardware abstraction layer of the device through a service layer of the device, wherein the image processing request comprises a to-be-processed image and a first handle corresponding to the to-be-processed image;
determining, by the hardware abstraction layer, a second handle corresponding to the first handle, and establishing a mapping relationship among the first handle, the to-be-processed image, and the second handle;
sending, by the hardware abstraction layer, the mapping relationship to a kernel of the device; and
after the kernel completes processing of the to-be-processed image, sending, by the kernel, first notification data to the application layer based on the first handle, and sending second notification data to the hardware abstraction layer based on the second handle, wherein the first notification data is used to notify the application layer that the processing of the to-be-processed image is completed, and the second notification data is used to notify the hardware abstraction layer that the processing of the to-be-processed image is completed.

9. The device according to claim 8, wherein the at least one processor executes the computer-executable instruction to further execute steps of:
obtaining a to-be-processed image;
sending, by the application layer, a first handle obtaining request to the service layer;
receiving, by the application layer, a first handle sent by the service layer, wherein the first handle is obtained by the service layer from a preset handle library; and
establishing, by the application layer, a correspondence between the first handle and the to-be-processed image.

10. The device according to claim 8, wherein the at least one processor executes the computer-executable instruction to further execute the step of:
deleting, by the hardware abstraction layer, the image processing request corresponding to the second handle from a request queue of the hardware abstraction layer based on the second handle.

11. The device according to claim 10, wherein the at least one processor executes the computer-executable instruction to further execute the step of:
adding, by the hardware abstraction layer, a completion identifier to a result queue of the hardware abstraction layer based on the second handle, wherein the completion identifier indicates that processing of the to-be-processed image corresponding to the second handle is completed.

12. The device according to claim 8, wherein the at least one processor executes the computer-executable instruction to execute the step of:
sending, by a driver program comprised in the kernel, the first notification data to the application layer based on the first handle.

13. The device according to claim 12, wherein the at least one processor executes the computer-executable instruction to execute steps of:
sending, by a driver program comprised in the kernel, the first handle to a synchronous driver comprised in the kernel; and
sending, by the synchronous driver, the first notification data to the application layer based on the first handle.

14. The device according to claim 12, wherein the at least one processor executes the computer-executable instruction to execute steps of:
sending, by a driver program comprised in the kernel, the first handle to a distributed database comprised in the kernel; and
sending, by the distributed database, the first notification data to the application layer based on the first handle.

15. A non-transitory computer-readable storage medium storing a computer-executable instruction, wherein a processor executes the computer-executable instruction to execute steps of:
sending, by an application layer of a virtual reality device, an image processing request to a hardware abstraction layer of the virtual reality device through a service layer of the virtual reality device, wherein the image processing request comprises a to-be-processed image and a first handle corresponding to the to-be-processed image;
determining, by the hardware abstraction layer, a second handle corresponding to the first handle, and establishing a mapping relationship among the first handle, the to-be-processed image, and the second handle;
sending, by the hardware abstraction layer, the mapping relationship to a kernel of the virtual reality device; and
after the kernel completes processing of the to-be-processed image, sending, by the kernel, first notification data to the application layer based on the first handle, and sending second notification data to the hardware abstraction layer based on the second handle, wherein the first notification data is used to notify the application layer that the processing of the to-be-processed image is completed, and the second notification data is used to notify the hardware abstraction layer that the processing of the to-be-processed image is completed.

16. The medium according to claim 15, wherein the processor executes the computer-executable instruction to further execute steps of:
obtaining a to-be-processed image;
sending, by the application layer, a first handle obtaining request to the service layer;
receiving, by the application layer, a first handle sent by the service layer, wherein the first handle is obtained by the service layer from a preset handle library; and
establishing, by the application layer, a correspondence between the first handle and the to-be-processed image.

17. The medium according to claim 15, wherein the processor executes the computer-executable instruction to further execute the step of:
deleting, by the hardware abstraction layer, the image processing request corresponding to the second handle from a request queue of the hardware abstraction layer based on the second handle.

18. The medium according to claim 17, wherein the processor executes the computer-executable instruction to further execute the step of:
adding, by the hardware abstraction layer, a completion identifier to a result queue of the hardware abstraction layer based on the second handle, wherein the completion identifier indicates that processing of the to-be-processed image corresponding to the second handle is completed.

19. The medium according to claim 15, wherein the processor executes the computer-executable instruction to execute the step of:
sending, by a driver program comprised in the kernel, the first notification data to the application layer based on the first handle.

20. The medium according to claim 15, wherein the processor executes the computer-executable instruction to execute steps of:
sending, by a driver program comprised in the kernel, the first handle to a synchronous driver comprised in the kernel; and
sending, by the synchronous driver, the first notification data to the application layer based on the first handle.
